(19) United States
(12) Patent Application Publication
(10) Pub. No.: US 2018/0317047 A1
(43) Pub. Date: Nov. 1, 2018

(54) ACTIVE RADIO FREQUENCY TAG INDOOR POSITIONING METHOD

(71) Applicant: Fa-Chi Hu, Hsinchu (TW)

(72) Inventor: Fa-Chi Hu, Hsinchu (TW)

(21) Appl. No.: 15/958,877

(22) Filed: Apr. 20, 2018

(30) Foreign Application Priority Data
Apr. 26, 2017 (CN) 201710280777.1

(51) Int. Cl. H04W 4/02; G01C 21/20; H04W 64/00

(52) U.S. Cl. CPC H04W 4/023; H04W 4/33; H04W 64/003; G01C 21/206

(57) ABSTRACT

An active radio frequency tag indoor positioning method, which includes a signal source, a plurality of sensing nodes, a server, at least one network bridge, and a determination module. The method uses signals actively transmitted from the signal source to each of the sensing nodes, which receive and produce data therefrom, which is then transmitted to the server. The server stores the data and carries out mutual comparison determination to calculate the signal source and the distance to each of the sensing nodes to determine the current position of the signal source. Accordingly, through active signal transmission to the sensing nodes, and using mutual comparison of a plurality of data recordings, the server is able to calculate the distance to the nearer sensing node, thus achieving the object of increasing positioning accuracy.

### BACKGROUND OF THE INVENTION

### (a) Field of the Invention

The present invention relates to an indoor positioning method, and more particularly relates to determination methods that enable calculating the current position through active signal transmission to sensing nodes and through a mutual comparison method.

### (b) Description of the Prior Art

Referring to FIG. 1, which shows a schematic view of current positioning technology, and it can be clearly seen from the drawing that the architecture of current technology comprises a base station 101 that transmits signals to each signal transmitting node 102, each of which cover a fixed distance. A signal receiving device 103 receives a signal when entering the transmitting range of the signal transmitting nodes 102, whereupon the signal receiving device 103 determines the position of its own current location using the signal source of each of the signal transmitting nodes 102.

However, the aforementioned method has the following problems:
1. Relatively poor accuracy.
2. The signal receiving device 103 needs relatively high functionality, such as that of a smart phone, and the signal transmitting ability of the signal transmitting nodes 102 entails a relatively high cost for the entire system.
3. The system is easily subjected to environment effects, resulting in relatively poor positioning effectiveness.

Hence, there is enormous room for improvement in current positioning technology.

### SUMMARY OF THE INVENTION

The object of the present invention lies in providing an active radio frequency tag indoor positioning method, wherein a signal source actively transmits signals to sensing nodes, which convert the signals into data. Each of the sensing nodes then transmits the data to a server that carries out mutual comparison thereof to calculate the distance of the signal source to each of the sensing nodes and which area thereof the signal source is currently in, and whether the distance is far or close.

In order to achieve the aforementioned object, the present invention proposes an active radio frequency tag indoor positioning method, wherein the system architecture comprises:

a signal source, which produces and actively transmits a signal;

a plurality of sensing nodes, which produce data after receiving the signal;

a server, which is connected to the sensing nodes and receives the data, a data storage module is provided within the server and is used to store data;

at least one network bridge, which is configured between the sensing nodes and the server; the network bridges are used to connect to the sensing nodes and the server, as well as serving as a medium for data interchange; and

a determination module, which is mounted within the server, wherein, after determining the data, the determination module additionally calculates the current position of the signal source.

The determination method of the present invention comprises the signal source actively transmitting a signal, with the sensing nodes producing data from the signal received, after which each of the sensing nodes transmits the data to the server for additional storage and mutual comparison determination to calculate the distance relationship of the signal source to each of the sensing nodes, thereby determining the current position of the signal source.

The aforementioned technological characteristics have improved the method of current positioning technology, and further overcomes the problems and provides improved solutions to the poor accuracy, high cost, and easily subjected to environment effects of current positioning technology, thereby achieving the object of increasing positioning accuracy.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a schematic view of current positioning technology.

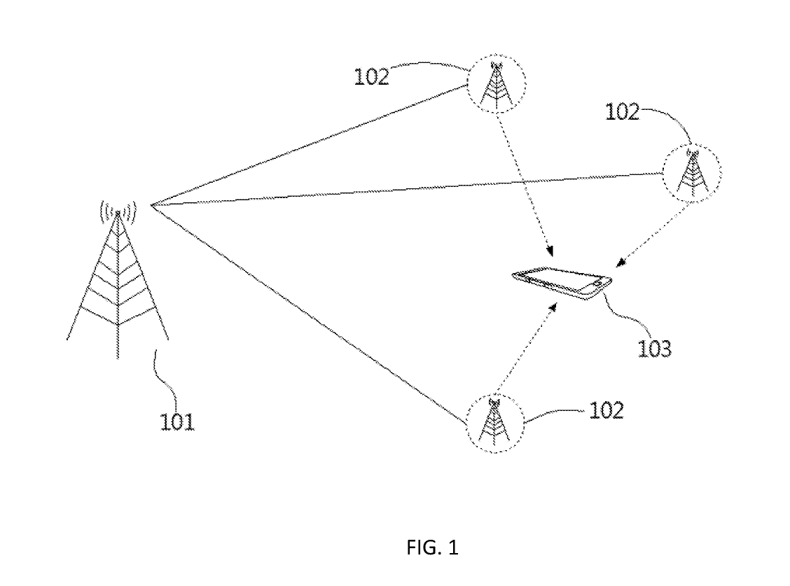

FIG. 2 is a schematic view of a system architecture of the present invention.

FIG. 3 is a schematic view depicting a closed area determination method in which the signal source is in different positions.

FIG. 4 is a schematic view depicting an open area determination method in which the signal source is in different positions.

FIG. 5 is a schematic view depicting another open area determination method in which the signal source is in different positions.

### DETAILED DESCRIPTION OF THE PREFERRED EMBODIMENTS

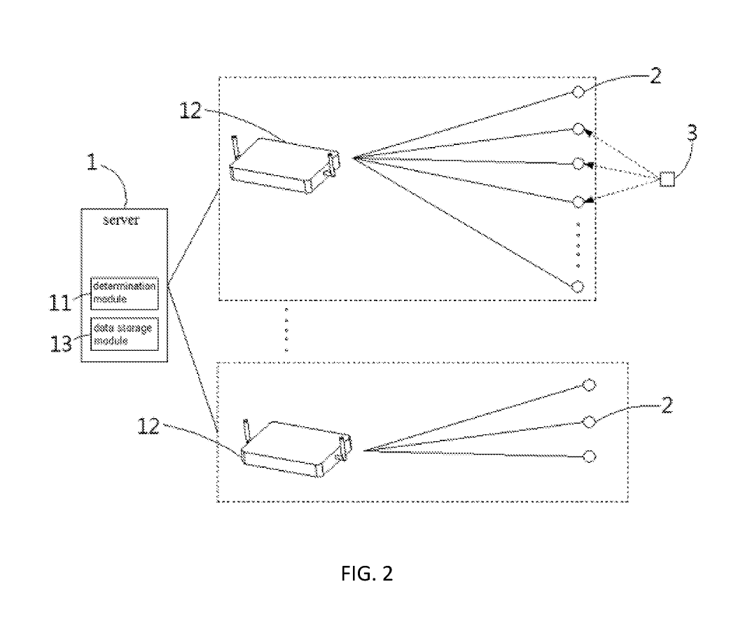

Referring to FIG. 2, which shows a schematic view of a system architecture of the present invention, and it can be clearly seen from the drawings that the entire system architecture comprises a server 1 acting as the system center that is outwardly connected to a plurality of network bridges 12 serving as relays. The network bridges 12 are further connected to a plurality of sensing nodes 2 to construct a tree-like architecture. A determination module 11 is provided within the server 1 for carrying out determination operations, and the server is further provided with a data storage module 13 that serves to provide storage space and record settings. The number of the network bridges 12 able to provide connections to the sensing nodes 2 depends on the design of the network bridges 12 and the number of the sensing nodes 2 they are able to support. In addition, a signal source 3 independently transmits a signal to the sensing nodes 2. In order to simplify the description of the following algorithmic determination methods, one of the network bridges 12 is connected to three of the sensing nodes 2 in the drawings.

More specifically, according to different applications, the algorithmic determination method used can be divided into an open area mode determination method for application in open areas and a close area mode determination method for application in closed areas. Open areas can be recognized as relatively large spaces (wherein a plurality of sensing nodes are used); and closed areas can be recognized as relatively small spaces (wherein only one sensing node is used).

More specifically, the relatively large spaces defined as the aforementioned open areas primarily point to large-scale indoor open spaces, such as corridors, lobbies, large lounges, museums, cinemas, department stores, and the like. If waterproof measures are added to the sensing nodes, then the system has additional applications in outdoor spaces, such as parks, playgrounds, and the like. And the relatively small spaces defined as the aforementioned closed areas primarily point to small rooms, small conference rooms, small offices, and the like.

The various definitions adopted in the following description are hereby proposed: wherein a plurality of distance intervals are defined according to the distance of the signal source 3 from the sensing nodes 2, for example, each 10 meters is defined as a space interval, and successively given the definitions “considerably close”, “close”, “normal”, “far”, “considerably far”, and so on, with the server 1 controlling and planning out the number of space intervals. For the sake of convenient description of the present invention, only the two states “close” and “far” are represented in the following descriptions, however, the present invention is not limited by such states.

A close area mode determination method only retains the data received from the last sensing node 2 that the signal source 3 has transmitted to, and, regardless of the state of the data, they are all acknowledged as being closest to the last sensing node 2, accordingly obtaining the results in the following Table 1:

TABLE 1

| State | Node A | Node B | Determined area |
|---|---|---|---|
| 1 | close | | A area |
| 2 | far | | A area |
| 3 | | far | B area |
| 4 | | close | B area |

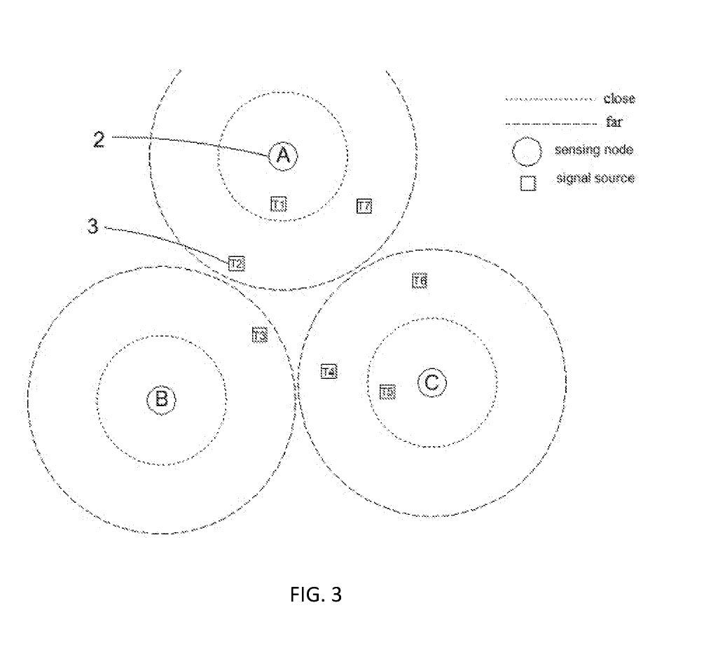

Referring to FIG. 3, which shows a schematic view depicting the closed area determination method in which the signal source is in different positions, and according to the above description, it can be understood that when the close area mode determination method is being applied in the architecture of FIG. 2, FIG. 3 shows actual adoption of the signal source 3 at different positions and different times, accordingly obtaining the results in the following Table 2:

TABLE 2

| Time | | | | Predicted | Determined | |
|---|---|---|---|---|---|---|
| point | Node A | Node B | Node C | data | area | Record |
| T1 | close | | | A-close | A area | None |
| T2 | far | | | A-far | A area | None |
| T3 | | far | | B-far | B area | None |
| T4 | | | far | C-far | C area | None |
| T5 | | | close | C-close | C area | None |
| T6 | | | far | C-far | C area | None |
| T7 | far | | | A-far | A area | None |

Accordingly, it can be understood that recording cannot be carried out under the close area mode determination method, and purely determines the area from where a sensing node receives a signal from the signal source 3, and determines that to be the immediate area.

However, an open area mode determination method retains each of the data, and compares the most recent predicted data and the immediate predicted data in a specified period. After which, if one of the sensing nodes obtains “close” data, the data is retained and “far” data of the other sensing nodes is ignored, unless when the “close” data of the sensing node is changed into “far” data, only then does the sensing node again accept “far” data. Hence, based on such determination logic, the results in the following Table 3 are obtained:

TABLE 3

| State | Node A | Node B | Determined area |
|---|---|---|---|
| 1 | close | | A area |
| 2 | far | | A area |
| 3 | far | far | AB area(between A & B) |
| 4 | far | close | B area |
| 5 | close | close | A area (if A-close is the |
| | | | newest) |

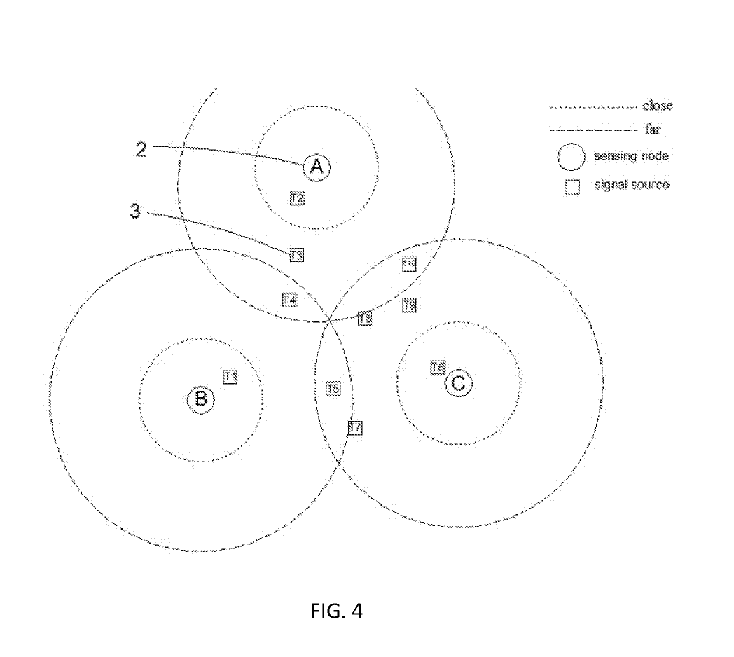

Referring to FIG. 4, which shows a schematic view depicting the open area determination method in which the signal source is in different positions, and according to the above description, it can be understood that FIG. 4 adopts the open area mode determination method, wherein the distance interval range has changed, enabling partial overlapping of the “far” space intervals of each of the sensing nodes. Applying the open area mode determination method in the architecture of FIG. 2, FIG. 4 shows actual adoption of the signal source 3 at different positions and different times, accordingly obtaining the results in the following Table 4:

TABLE 4

| Time | Node | Node | Node | Predicted | Determined | |
|---|---|---|---|---|---|---|
| point | A | B | C | data | area | Record |
| T1 | | close | | B-close | B area | Retain B-close |
| T2 | close | | | A-close | A area | Retain A-close |
| T3 | far | | | A-far | A area | Retain A-far |
| T4 | | far | | A-far & | AB area | Retain B-far |
| | | | | B-far | | |
| T5 | | | far | B-far & | BC area | Retain C-far |
| | | | | C-far | | |
| T6 | | | close | C-close | C area | Retain C-close |
| T7 | | far | | C-close | C area | Ignore B-far |
| | | | | | | Retain C-close |
| T8 | far | | | C-close | C area | Ignore A-far |
| | | | | | | Retain C-close |
| T9 | | | far | C-far | C area | Retain C-far |
| T10 | far | | | C-far & | AC area | Retain A-far |
| | | | | A-far | | |

Under the aforementioned conditions, different results are obtained according to different time points. The following provides a description:

Time points T1 and T2 are the times when node B and node A respectively receive a signal from the signal source, therefore, the determined areas are B area and A area, respectively, with the recorded states continually refreshed.

Time point T3 is the time when the signal received by node A changes to “far”, the record similarly retains the determined area as A area, while retaining the recorded state as “A-far”.

Time point T4 is the time when the signal “far” is received by node B, and because the preceding record “A-far” is still retained, thus, the predicted data includes the two records “A-far” and “B-far”, therefore the area is determined to be AB area, and the state is recorded as “A-far” removed, retain “B-far”.

Time point T5 is the time when the signal “far” is received by node C, and because the preceding record “B-far” is retained, thus, the predicted data includes the two records “B-far” and “C-far”, therefore the area is determined to be BC area, and the state is recorded as “B-far” removed, retain “C-far”.

Time point T6 is the time when the signal “close” is received by node C, and because the right of “close” is greater than that of “far”, thus, the predicted data is “C-close”, therefore the area is determined to be C area, and the state is recorded as retain “C-close”.

Time point T7 is the time when the signal “far” is received by node B, and although the current condition is possibly located in BC area, however, the signal received by node B is possibly an excessive wave. Moreover, because the right of “close” is greater than that of “far”, thus, the predicted data uses the preceding record of “C-close” and ignores “B-far”, therefore the area is determined to be C area, and the state is recorded as retain “C-close”.

Time point T8 is the time when the signal “far” is received by node A, and although the current condition is possibly located in AC area, however, the signal received by node A is possibly an excessive wave. Moreover, because the right of “close” is greater than that of “far”, thus, the predicted data uses the preceding record of “C-close” and ignores “A-far”, therefore the area is determined to be C area, and the state is recorded as retain “C-close”.

Time point T9 is the time when the signal “far” is received by node C, and can be recognized as a signal source from a position very close to node C that has moved to a relatively further position, thus, the predicted data is changed to “C-far”, therefore the area is determined to be C area, and the state is recorded as retain “C-far”.

Time point T10 is the time when the signal “far” is received by node A, and because the preceding record “C-far” is still retained, thus, the predicted data includes the two records “C-far” and “A-far”, therefore the area is determined to be AC area, and the state is recorded as “C-far” removed, retain “A-far”.

Under the aforementioned conditions, time points T1, T2, T3, and T6 pertain to circumstances wherein the open area mode determination method is applied “when the server has only first area or second area data of one of the sensing nodes 2, then the server will retain this data and determine the position to be in the vicinity of the respective sensing node.” Time points T7, T8 pertain to circumstances wherein the open area mode determination method is applied “after the signal source 3 enters the first area of one of the sensing nodes 2, the server will retain the respective data of the first area and overlook the data from the signal source 3 entering the second area of other sensing nodes, therefore determining the position of the signal source to be in the vicinity of the sensing node of the first area.” Time point T9 pertains to circumstances wherein the open area mode determination method is applied “after the signal source enters a second area from one of the first areas of the sensing nodes, the server retains the data of the signal source of the second area of the sensing nodes and again receives the second area data of the signal source entering other sensing nodes.” Time points T4, T5 pertain to circumstances wherein the open area mode determination method is applied “after the signal source successively enters the second area of a sensing node, the server retains the second area data of the latest sensing node and determines the position to be between two sensing nodes.”

And under the relatively less common circumstances wherein the open area mode determination method is applied “after the signal source enters a first area of one of the sensing nodes, the server retains the first area data of the sensing node. When first area data of a new sensing node is produced, the server retains the first area data of the new sensing node and determines the position to be in the vicinity of the new sensing node. The server thus selects the data that needs to be retained according to the above principles, and successively makes a comparison with the area data of the new sensing node to determine the position of the signal source.” Because the displacement speed of the signal source and frequency of the received signals are taken into consideration, therefore, when the signal source quickly directly enters the first area of another sensing node from the first area of a sensing node, then there is the possibility of abnormalities occurring.

In substance, the server is still able to extrapolate which one of the preceding 1 to 4 types of circumstances the situation pertains to according to other data and conditions.

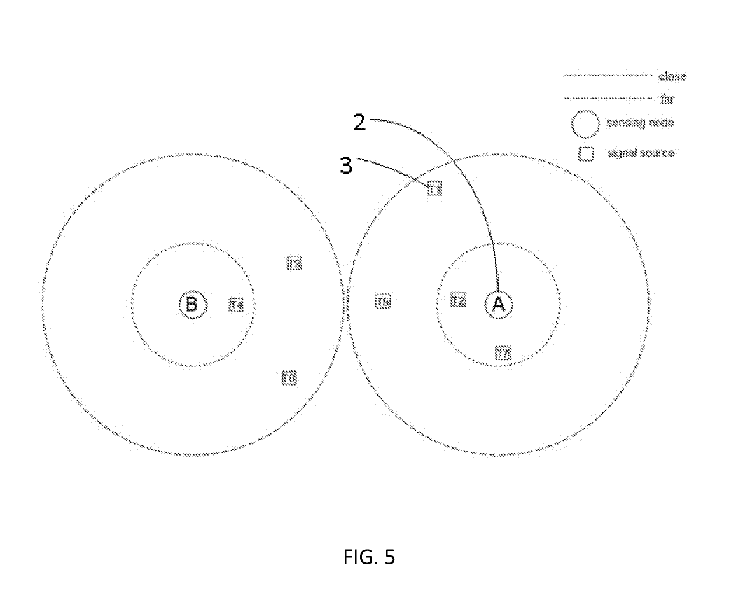

Referring to FIG. 5, which shows a schematic view depicting another open area determination method in which the signal source is in different positions, and this other open area mode determination method is applied based on “after a signal source successively enters the first area of a sensing node, the server retains the first area data of the foremost sensing node, and after the signal source successively enters the second area of a sensing node, the server retains the second area data of the rearmost sensing nodes.” In other words, this is a method using a “close” state as the primary position determining method, wherein each signal source (electronic tag) is provided with the states of “close” or “far” corresponding to the different sensing nodes, with the addition of the times the states change to determine the position of the signal source enables obtaining the results in the following Table 5:

TABLE 5

| | | | Determined | |
|---|---|---|---|---|
| Time point | Node A | Node B | area | Record |
| T1 | far | | Original node | A-far |
| | | | (not determined) | |
| T2 | close | | Node A | A-close |
| T3 | | far | Node A | A-close & B-far |
| T4 | | close | Node A | A-close & B-close |
| T5 | far | | Node B | B-close & A-far |
| T6 | | far | Node B | B-far & A-far |
| T7 | close | | Node A | A-close & B-far |

Under the aforementioned conditions, diverse results are obtained according to different time points. The following provides a description:

Time point T1 is the time when node A receives a “far” signal, and because there is no “close” state, thus, no determination is carried out and no record is made, therefore the initial position fixed by the system is maintained.

Time point T2 is the time when node A receives a “close” signal, and according to the determination method of the present embodiment, a “close” state is used to replace the initial position fixed by the system, thus, the condition here is determined for node A and recorded as A-close.

Time point T3 is the time when node B receives a “far” signal, however, according to the determination method of the present embodiment, a “far” state is unable to replace the “close” state, thus, the condition here is determined for node A and recorded as A-close & B-far.

Time point T4 is the time when node B receives a “close” signal, however, according to the determination method of the present embodiment, the first “close” state (i.e., A-close) is maintained, thus, the condition here is determined for node A and recorded as A-close & B-close.

Time point T5 is the time when node A receives a “far” signal, and because A is changed to a “far” state, according to the determination method of the present embodiment, thus, the condition here is determined for node B and recorded as B-close & A-far.

Time point T6 is the time when node B receives a “far” signal, (that is, no nodes are in the “close” state, thus the position of the previous node is retained, and because nodes A and B are both in “far” states, according to the determination method of the present embodiment, the condition here is determined for node B and recorded as B-far & A-far.

Time point T7 is the time when node A receives a “close” signal, thus, the condition here is determined for node A and recorded as A-close & B-far.

In the determination methods described above, in order to leave out determination of the intermediate points, only the node of any nearest neighboring area is determined, thereby minimizing complexity of the determination and speeding up the entire determination process.

The position prediction system architecture and determination method art of the present invention has enabled improving the problems and shortcomings of the current art, and mutual comparison of a plurality of data recordings enables calculating the distance to the nearest sensing node, thereby achieving the object of increasing positioning accuracy.

In addition, in practical applications, a plurality of groups can be set up at the same time, respectively adopting different determination methods. More specifically, one group could be currently only able to use one type of determination method, such as the open area mode or the close area mode determination method, and when a group of determination methods are changed to some extent, the previous records are disposed of.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An active radio frequency tag indoor positioning method, which uses a signal actively transmitted from a signal source to each of a plurality of sensing nodes that receive and produce data therefrom, whereafter each of the sensing nodes transmits the data to a server, the server stores the data and accords to the distance relationship of the signal source to each of the sensing nodes carries out mutual comparison, determining the current position of the signal source.

2. The active radio frequency tag indoor positioning method according to claim 1, wherein an open area mode determination method and a close area mode determination method are provided within the server, and using either the open area mode determination method or the close area mode determination method, each of the sensing nodes receives a signal transmitted by the signal source, whereupon the determination method calculates whether the current distance of the position of the signal source from the sensing nodes is far or close according to the signal strength received; moreover, the distance interval of the signal source position corresponding to the sensing node is defined according to whether the signal source distance from the sensing node is far or close, and according to whether the signal source position from the sensing node is far or close, the distance intervals are further defined and differentiated as a first area that is relatively close to the sensing node and a second area that is relatively far from the sensing node.

3. The active radio frequency tag indoor positioning method according to claim 1, wherein, in the open area mode determination method, when the server has only first area or second area data of a single sensing node, the server retains this data and determines the signal source position to be in the vicinity of the sensing node.

4. The active radio frequency tag indoor positioning method according to claim 1, wherein, in the open area mode determination method, after the signal source enters the first area of one of the sensing nodes, the server retains this data and determines the position to be in the vicinity of the sensing node, overlooking the signal source having entered the second area data of other sensing nodes.

5. The active radio frequency tag indoor positioning method according to claim 1, wherein, in the open area mode determination method, after the signal source enters a second area from the first area of one of the sensing nodes, the server retains the second area data of the sensing node and re-receives the signal source having entered the second area data of other sensing nodes.

6. The active radio frequency tag indoor positioning method according to claim 1, wherein, in the open area mode determination method, after the signal source sequentially enters the second areas of the sensing nodes, the server retains the second area data of the latest sensing node and determines the position to be between two sensing nodes.

7. The active radio frequency tag indoor positioning method according to claim 1, wherein, in the open area mode determination method, after the signal source enters the first area of one of the sensing nodes, the server retains the first area data of the sensing node; when first area data of a new sensing node is produced, the server retains the first area data of the new sensing node and determines the position to be in the vicinity of the new sensing node; according to the above principles, the server selects the data that needs to be retained and sequentially compares the area data of new sensing nodes to determine the position of the signal source.

8. The active radio frequency tag indoor positioning method according to claim 1, wherein, in the open area mode determination method, after the signal source sequentially enters the first areas of the sensing nodes, the server retains the first area data of the foremost sensing node; after the signal source sequentially enters the second areas of the sensing nodes, the server retains the second area data of the rearmost sensing node.

9. The active radio frequency tag indoor positioning method according to claim 1, wherein, in the close area mode determination method, after the signal source enters the first area of one of the sensing nodes, the server stores and determines the signal source is currently close to the sensing node.

10. The active radio frequency tag indoor positioning method according to claim 1, wherein, in the close area mode determination method, after the signal source enters the first area or the second area of another sensing node from one of the sensing nodes, the server stores and determines the signal source is currently close to the newly entering sensing node and sequentially deletes the older data.
